(19) United States
(12) Patent Application Publication
(10) Pub. No.: US 2008/0313332 A1
(43) Pub. Date: Dec. 18, 2008

(54) METHODS AND APPARATUS FOR RESOURCE MANAGEMENT IN A COMMUNICATION NETWORK

(75) Inventors: Jun Wang, La Jolla, CA (US); Fatih Ulupinar, San Diego, CA (US); Peerapol Tinnakornsrisuphap, San Diego, CA (US); Raymond Tah-Sheng Hsu, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/136,584

(22) Filed: Jun. 10, 2008

Related U.S. Application Data
(60) Provisional application No. 60/944,691, filed on Jun. 18, 2007.

(51) Int. Cl. G06F 15/16

(52) U.S. Cl. 709/226

(57) ABSTRACT

A method for resource management in a communication network may include monitoring whether a Proxy Mobile Internet Protocol (PMIP) tunnel between a network entity and another network entity is still needed. The method may also include detecting an event which indicates that the PMIP tunnel is no longer needed. The method may also include cleaning resources of the network entity that support the PMIP tunnel.

### RELATED APPLICATIONS

This application is related to and claims priority from U.S. Patent Application Ser. No. 60/944,691, filed Jun. 18, 2007, for “Resource Management in a Communication Network,” which is incorporated herein by reference.

### TECHNICAL FIELD

The present disclosure relates generally to communication systems. More specifically, the present disclosure relates to methods and apparatus for resource management in a communication network.

### BACKGROUND

As used herein, the term “access terminal” refers to an electronic device that may be used for voice and/or data communication over a wireless communication network. Examples of access terminals include cellular phones, personal digital assistants (PDAs), handheld devices, wireless modems, laptop computers, personal computers, etc. An access terminal may alternatively be referred to as a mobile station, a mobile terminal, a subscriber station, a remote station, a user terminal, a terminal, a subscriber unit, user equipment, etc.

A wireless communication network may provide communication for a number of access terminals, each of which may be serviced by a base station. A base station may alternatively be referred to as an access point, a Node B, or some other terminology.

An access terminal may communicate with one or more base stations via transmissions on the uplink and the downlink. The uplink (or reverse link) refers to the communication link from the access terminal to the base station, and the downlink (or forward link) refers to the communication link from the base station to the access terminal.

The resources of a wireless communication network (e.g., bandwidth and transmit power) may be shared among multiple access terminals. A variety of multiple access techniques are known, including code division multiple access (CDMA), time division multiple access (TDMA), frequency division multiple access (FDMA), and orthogonal frequency division multiple access (OFDMA).

### BRIEF DESCRIPTION OF THE DRAWINGS

FIG. 1 illustrates an example of an Ultra Mobile Broadband (UMB) network;

FIG. 2 illustrates examples of resources that may be utilized to maintain bindings;

FIG. 3 illustrates examples of resources that may be managed and/or updated on an access gateway (AGW);

FIG. 4 illustrates examples of resources that may be managed and/or updated on a home agent (HA)/local Mobility Anchor (LMA);

FIG. 5 illustrates a PMIP lifetime parameter being used to trigger updates of resources;

FIG. 6 illustrates a foreign agent (FA) binding between an HA and an AGW and PMIP Binding between the LMA and AGW being refreshed;

FIG. 7 illustrates resources of an AGW and an evolved base station (eBS);

FIG. 8 illustrates how the resource update and management processes as mentioned above may be applicable to the Access Network (AN)-initiated Data Attachment Point (DAP) Move;

FIG. 9 illustrates how the resource update and management processes as mentioned above may be applicable to the AT-assisted DAP Move;

FIG. 10 illustrates an example of a possible remedy relating to resource management in the event of PMIP tunnel failure;

FIG. 11 illustrates another example of a possible remedy relating to resource management in the event of PMIP tunnel failure;

FIG. 12 illustrates examples of other ways to trigger the cleaning and/or updating of resources;

FIG. 13 illustrates additional examples of ways to trigger the cleaning and/or updating of resources;

FIG. 14 illustrates additional examples of ways to trigger the cleaning and/or updating of resources;

FIG. 15 illustrates additional examples of ways to trigger the cleaning and/or updating of resources;

FIG. 16 illustrates a method for management of resources in a communication network;

FIG. 16A illustrates means-plus-function blocks corresponding to the method of FIG. 16; and

FIG. 17 shows part of a hardware implementation of an apparatus for resource management in a communication network.

### DETAILED DESCRIPTION

A network entity that is configured for resource management in a communication network is disclosed. The network entity includes a processor. The network entity may also include circuitry coupled to said processor configured to monitor a Proxy Mobile Internet Protocol (PMIP) tunnel between the network entity and another network entity, detect an event which indicates that the PMIP tunnel is no longer needed, and clean resources of the network entity that support the PMIP tunnel.

A network entity that is configured for resource management in a communication network is disclosed. The network entity may include means for monitoring whether a Proxy Mobile Internet Protocol (PMIP) tunnel between the network entity and another network entity is still needed. The network entity may also include means for detecting an event which indicates that the PMIP tunnel is no longer needed. The network entity may also include means for cleaning resources of the network entity that support the PMIP tunnel.

A computer product for resource management in a communication network is disclosed. The computer product includes a computer-readable medium. The computer-readable medium may include physically embodied computer-readable code for monitoring whether a Proxy Mobile Internet Protocol (PMIP) tunnel between a network entity and another network entity is still needed. The computer-readable medium may also include code for detecting an event which indicates that the PMIP tunnel is no longer needed. The computer-readable medium may also include code for cleaning resources of the network entity that support the PMIP tunnel.

A method for resource management in a communication network is disclosed. The method may be implemented by a network entity. The method may include monitoring whether a Proxy Mobile Internet Protocol (PMIP) tunnel between the network entity and another network entity is still needed. The method may also include detecting an event which indicates that the PMIP tunnel is no longer needed. The method may also include cleaning resources of the network entity that support the PMIP tunnel.

The techniques described herein may be used for various wireless communication systems such as CDMA, TDMA, FDMA, OFDMA, SC-FDMA and other systems. The terms “system” and “network” may be used interchangeably herein. A CDMA system may implement a radio technology such as Universal Terrestrial Radio Access (UTRA), cdma2000, etc. UTRA includes Wideband CDMA (W-CDMA) and other CDMA variants. The cdma2000 technology covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.20, IEEE 802.16 (WiMAX), 802.11 (WiFi), Flash-OFDM.RTM., etc. UTRA and E-UTRA are part of UMTS. 3GPP Long Term Evolution (LTE) is a release of UMTS that uses E-UTRA. UTRA, E-UTRA, UMTS, LTE and GSM are described in documents from an organization named the “3rd Generation Partnership Project” (3GPP). UMB and cdma2000 are described in documents from an organization named the “3rd Generation Partnership Project 2” (3GPP2).

Some of the examples described herein use terminology that is relevant to Ultra Mobile Broadband (UMB) technology. However, these examples should not be interpreted as limiting the scope of the present disclosure. The present disclosure may also be applicable to other technologies, such as some or all of the technologies mentioned above.

Various examples are now described with reference to the drawings. In the following description, for purposes of explanation, numerous specific details are set forth in order to provide a thorough understanding of one or more aspects. It may be evident, however, that such aspects(s) may be practiced without these specific details. In other instances, well-known structures and devices are shown in block diagram form in order to facilitate describing one or more examples.

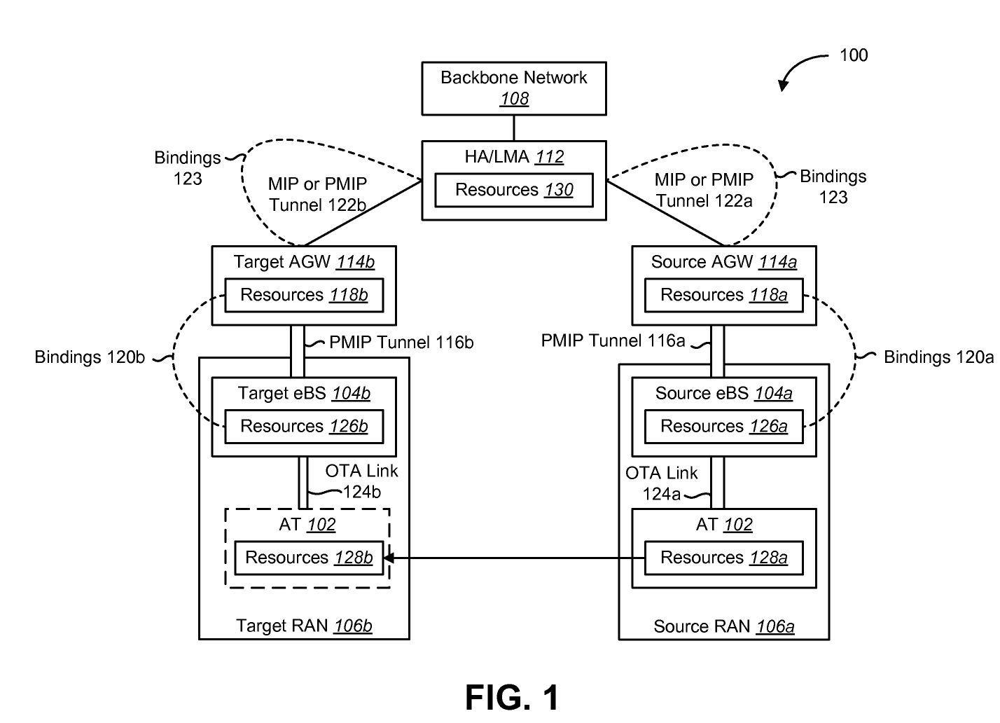

Reference is now made to FIG. 1. FIG. 1 illustrates an example of an Ultra Mobile Broadband (UMB) network 100.

A UMB network 100 may include a Home Agent (HA)/Local Mobility Agent (LMA) 112. The HA/LMA 112 may have direct access to a backbone network 108, such as the Internet. The HA/LMA 112 may be linked to a plurality of Access Gateways (AGWs) 114. Each AGW 114 may be connected to a plurality of evolved Base Stations (eBSs) 104. An eBS 104 may serve as a data exchange entity between an Access Terminal (AT) 102 and an AGW 114. The eBSs 104 and the ATs 102 may operate within a Radio Network (RAN) 106.

An AT 102 may be mobile and may roam from one RAN 106 to another operating under various protocols, such as IPv4, Mobile IPv4 (MIPv4), IPv6, and Mobile IPv6 (MIPv6), as promulgated by the Internet Engineering Task Force (IETF). An AT 102 may communicate with an eBS 104 within a RAN 106 for access of a backbone network 108 under the IPv4, IPv6, MIPv4 protocol and/or the MIPv6 protocol. When an AT 102 assumes a particular protocol to access the backbone network 108, resources 118, 126, 128, 130 of the various communication entities within the network 100 may be deployed.

Exchange of data packets between the backbone network 108 and the AT 102 may be through the eBS 104 as well as other entities, such as the HA/LMA 112 and the AGW 114. Data packets received by the AGW 114 from the backbone network 108 may be encapsulated before the data packets are sent to the correct eBS 104. The encapsulation may be carried out under the Proxy Mobile Internet Protocol (PMIP), and a PMIP tunnel 116 may be established between the AGW 114 and the eBS 104. Resources 118 from the AGW 114 and resources 126 from the eBS 104 that are utilized to establish the PMIP tunnel 116 may be called bindings 120. The same may be true with the reverse data traffic flowing in the reverse direction.

In a somewhat similar manner, data packets received by the HA/LMA 112 from the backbone network 108 may be encapsulated before the data packets are sent to the AGW 114. The encapsulation may be carried out under a Mobile Internet Protocol (MIP) protocol (e.g., MIPv4, MIPv6) or the PMIP protocol. With proper data packet encapsulation, data can flow from the HA/LMA 112 to the AGW 114. An MIP or PMIP data tunnel 122 may be established between the HA/LMA 112 and the AGW 114. Resources 130 from the HA/LMA 112 and resources 118 from the AGW 114 that are utilized to establish the MIP or PMIP data tunnel 122 may be called bindings 123. The same may be true with the reverse data traffic flowing in the opposite direction.

For an efficiently operating communication network 100, the resources 118, 126, 130 for supporting the bindings 120, 123 may be timely updated to reflect the ever-changing binding dynamics. The updating of resources 118, 126, 130 can occur under several scenarios.

For example, in an inter-AGW 114 handoff, the resources 118 on both the source AGW 114a and the target AGW 114b may be updated. In addition, the resources 126 on both the source eBS 104a and the target eBS 104b may also be updated. Suppose the AT 102 moves away from the source eBS 104a in the source RAN 106a to the target RAN 106b and thereafter establishes a communication link with the target eBS 104b. Resources 118a, 126a associated with the old bindings 120a between the source AGW 114a and the source eBS 104a for the PMIP tunnel 116a may be updated, possibly in the form of erasure. Likewise, resources 118b, 126b associated with the target bindings 120b between the target AGW 114b and the target eBS 104b for the PMIP tunnel 116b may be established. Also, resources 118a, 130 associated with the bindings 123 between the HA/LMA 112 and the source AGW 114a and the bindings 123 between the HA/LMA 112 and the target AGW 114b may also be updated. In addition, resources 126a, 128a associated with an over-the-air (OTA) link 124a between the source eBS 104a and the AT 102 may be updated, possibly in the form of erasure. Resources 126b, 128b associated with an OTA link 124b between the target eBS 104b and the AT 102 may be established. Thus, there may be updates and refreshments of resources 118, 126, 128, 130 involving various entities, such as the source AGW 114a, target AGW 114b, source eBS 104a, target eBS 104b, HA/LMA 112, and AT 102.

As another example, instead of an inter-AGW 114 handoff, suppose the AT 102 powers down or stays out of reach for a prolonged period of time. In such a scenario, resources 130, 118 may be updated between the HA/LMA 112 and the AGW 114, respectively. For example, some of the resources 130, 118 may be cleaned up (e.g., deleted).

Still, there may be other occasions, for example, based on administration-related reasons, where it may be desirable for resources 118, 126, 128, 130 to be updated. For instance, suppose that the subscriber of the AT 102 decides to terminate the service. In this situation, it may be desirable to update at least the resources 130 in the HA/LMA 112.

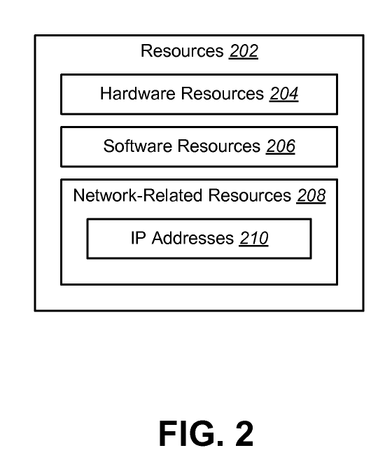

Reference is now made to FIG. 2. FIG. 2 illustrates examples of resources that may be utilized to maintain bindings 120, 123.

Resources 202 that may be utilized to maintain the bindings 120, 123 as aforementioned may include hardware resources 204 and software resources 206 of the various communication entities. In addition, the resources 202 may also include network-related resources 208. Examples of network-related resources 208 may include the finite number of IP addresses 210 assigned under the Dynamic Host Control Protocol (DHCP), if the DHCP is utilized.

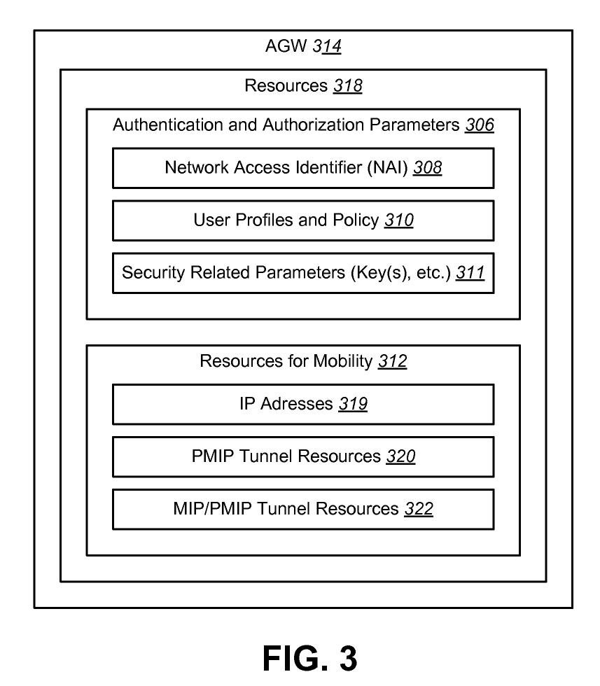

Reference is now made to FIG. 3. FIG. 3 illustrates examples of resources 318 that may be managed and/or updated on an AGW 314.

For an AGW 314, management or updating of resources 318 may include refreshing of the various authentication and authorization parameters 306. Examples of such parameters 306 may include a Network Access Identifier (NAI) 308, user profiles and policy 310, security-related parameters 311 (key(s), etc.) and so forth. Resources 312 may also be updated for the AGW 314 to deal with the roaming ATs 102. These resources 312 may be referred to as resources for mobility 312. The resources for mobility 312 may include IP addresses 319. As mentioned in the example above, when an AT 102 terminates a communication link associated with the AGW 314, resources 320 for supporting the PMIP tunnel 116 may be cleaned up (e.g., deleted). Likewise, resources 322 for supporting the MIP/PMIP tunnel 122 may be erased.

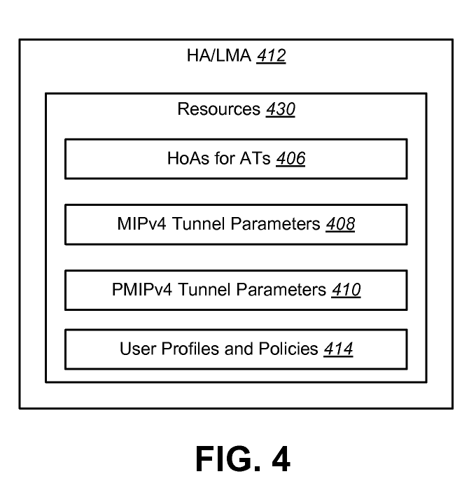

Reference is now made to FIG. 4. FIG. 4 illustrates examples of resources 430 that may be managed and/or updated on an HA/LMA 412.

For an HA/LMA 412, Home Addresses (HoAs) 406 associated with the subscribing ATs 102 and the various parameters 408, 410 relating to the MIPv4/PMIPv4 tunnels 122 may be among the resources 430 that are updated. Similar resources 430 may be updated if the MIPv6/PMIPv6 protocol is used. Also, user profiles and policies 414 may be among the resources 430 that are updated.

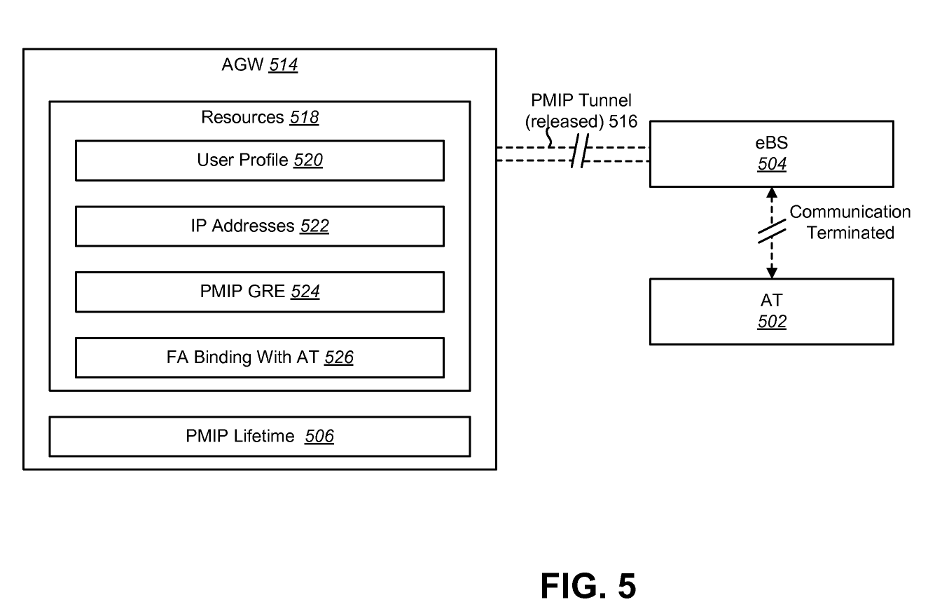

Reference is now made to FIG. 5. FIG. 5 illustrates a PMIP lifetime parameter 506 being used to trigger updates of resources 518.

Suppose that an AT 502 moves away from and terminates communication with an eBS 504. A PMIP tunnel 516 between an AGW 514 and the eBS 504 may be released, resulting in the expiration of the PMIP lifetime parameter 506. This expiration of the PMIP lifetime parameter 506 can be used to trigger the AGW 514 to clean up (e.g., delete) various resources 518, such as the user profile 520, IP addresses 522, PMIP Generic Routing Encapsulation (GRE) 524, Foreign Agent (FA) binding 526 associated with the AT 502, etc.

Thus, the PMIP lifetime parameter 506 is an example of one way to monitor whether the PMIP tunnel 516 is still needed. Also, the expiration of the PMIP lifetime parameter 506 is an example of an event which indicates that the PMIP tunnel 516 is no longer needed.

Resource management and/or update procedures may be automatic. For example, the AGW 514 may automatically clean up (e.g., delete) the resources 518 in response to the expiration of the PMIP lifetime parameter 506.

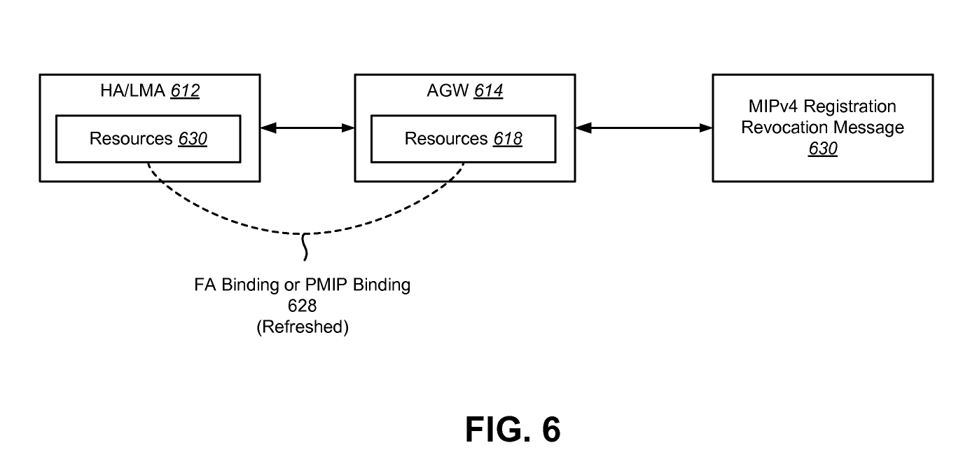

Other parameters can also be used to initiate the resource update process. For instance, reference is now made to FIG. 6. FIG. 6 illustrates an FA or PMIP binding 628 between an HA/LMA 612 and an AGW 614 being refreshed when the AGW 614 receives an MIPv4 registration revocation message 630, as set forth in Request for Comments (RFC) 3543.

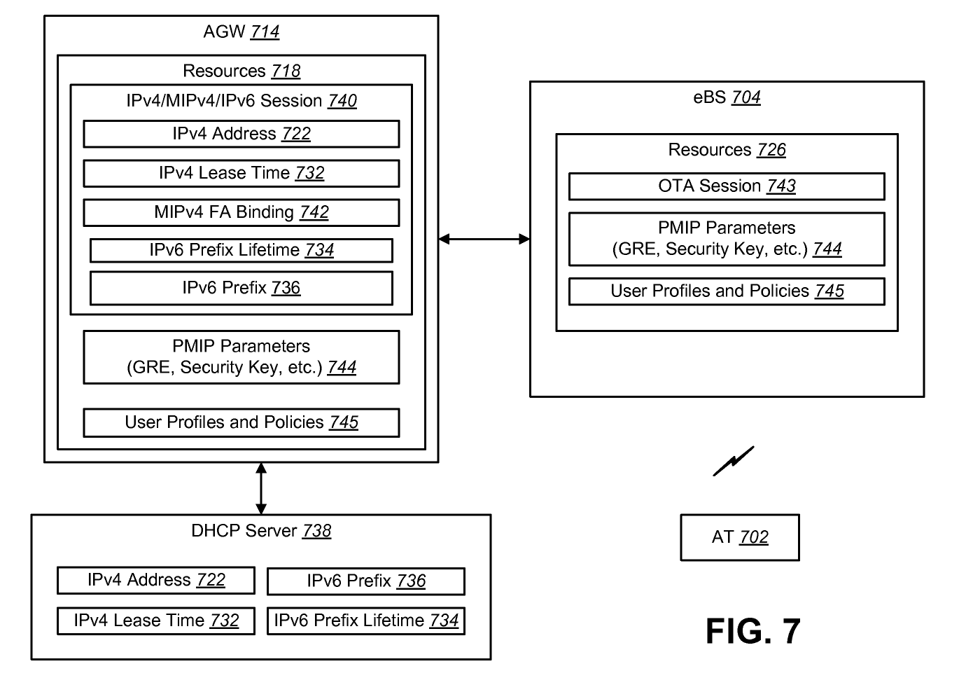

Reference is now made to FIG. 7. FIG. 7 illustrates an AGW 712 and an eBS 704 releasing IP addresses.

For instance, suppose that IPv4 is used instead of MIPv4. When the lease time 732 expires, the IPv4 address 722 can be released as part of the update process. Likewise, if IPv6 is used instead of MIPv6, when the IPv6 prefix lifetime 734 expires, the IPv6 prefix 736 can be released as part of the resource update.

However, if there is a DHCP server 738 included in or linked to the AGW 714, the DHCP server 738 may keep the IP address (e.g., the IPv4 address 722 if IPv4 is used and/or the IPv6 prefix 736 if IPv6 is used) of the AT 702 for a predetermined period of time to allow for the possibility that the AT 702 may return and resume communicating with the eBS 704 later. Nevertheless, in such a scenario, even though the IP address 722, 736 in the DHCP server 738 may be readily available, the AT 702 may re-establish the communication link with the eBS 704 via a new Extensible Authentication Protocol (EAP) access authentication process.

While the AGW 714 may update the resources 718 in the manner as described above, there may not be any impact to the IPv4/MIPv4/IPv6/MIPv6 session 740 as long as the MIPv4 FA binding 742 or MIPv6 binding has not expired. This may be because the same IP address may be used until the termination of the IPv4/MIPv4/IPv6/MIPv6 session 740.

The resources 718 on the AGW 714 may include PMIP parameters 744 (e.g., GRE, security key, etc.), user profiles and policies 745. The resources 726 on the eBS 704 may include an over-the-air (OTA) session 743, PMIP parameters 744 (e.g., GRE, security key, etc.), user profiles and policies 745, and so forth.

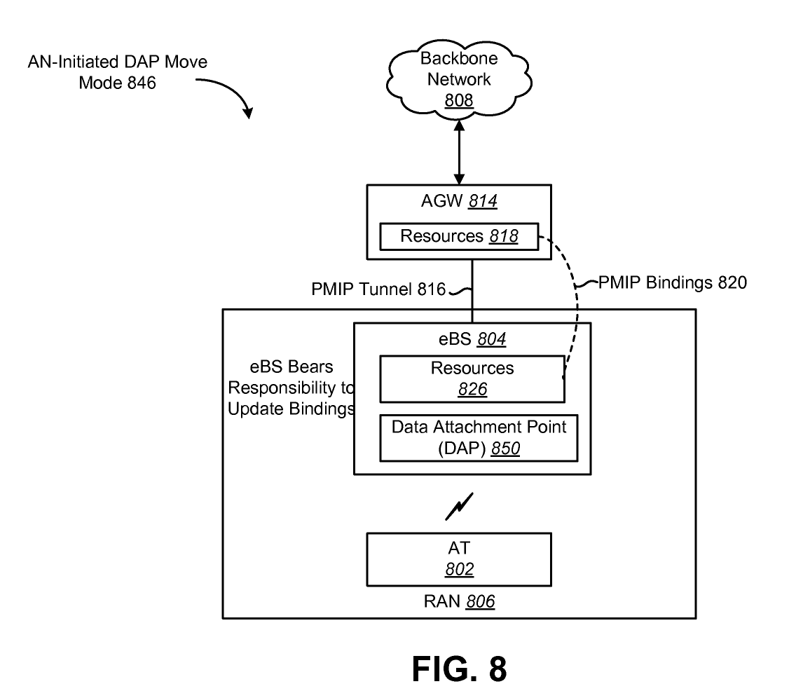

Reference is now made to FIG. 8. FIG. 8 illustrates how the resource update and management processes as mentioned above may be applicable to an Access Network (AN)-initiated Data Attachment Point (DAP) move 846.

It may be the responsibility of the DAP 850 to refresh and update the PMIP bindings 820. For instance, suppose that the AT 802 is accessing the backbone network 808 via, among other entities, the eBS 804. Data packets to and from the AT 802 may not be routed to other eBSs 804 in this example. The eBS 804 may serve as the DAP 850 for the AT 802. In an AN-initiated resource update, the eBS 804 may bear the responsibility to refresh and update the PMIP bindings 820 (i.e., resources 818 from the AGW 814 and resources 826 from the eBS 804 that are utilized to establish the PMIP tunnel 816).

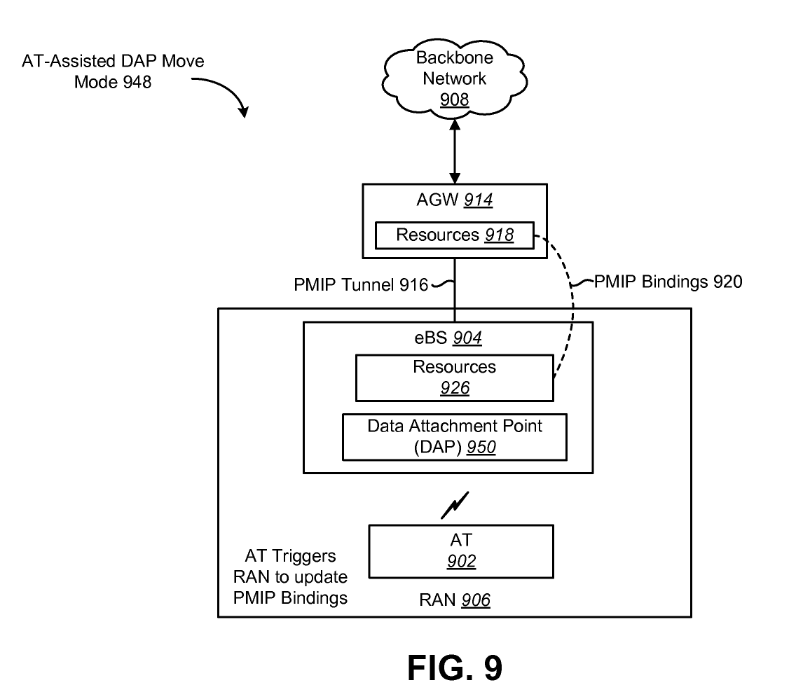

Reference is now made to FIG. 9. FIG. 9 illustrates how the resource update and management processes as mentioned above may be applicable to an AT-assisted DAP move 948.

During the AT-assisted DAP move 948, it may be the responsibility of the AT 902 to trigger the RAN 906 for refreshing or updating the PMIP bindings 920 between the AN 906 and the AGW 914. Thus, in the immediate example above, it may be the responsibility of the AT 902 to initiate or cause the AN 906 to refresh or update the PMIP bindings 920 between the AGW 914 and the eBS 904.

In the following paragraphs, the various scenarios and consequential remedies relating to resource management in the event of PMIP tunnel 116 failures are described. For reasons of clarity and simplicity in explanation, specific examples are elaborated. It should be noted that the scope of the present disclosure is not limited to the examples as described. Deviations and variations from the examples are clearly possible. In the examples below, the code fields with the associated numbers are with reference to messages as set forth in Request For Comments (RFC) 3344 which is published by the Internet Engineering Task Force (IETF).

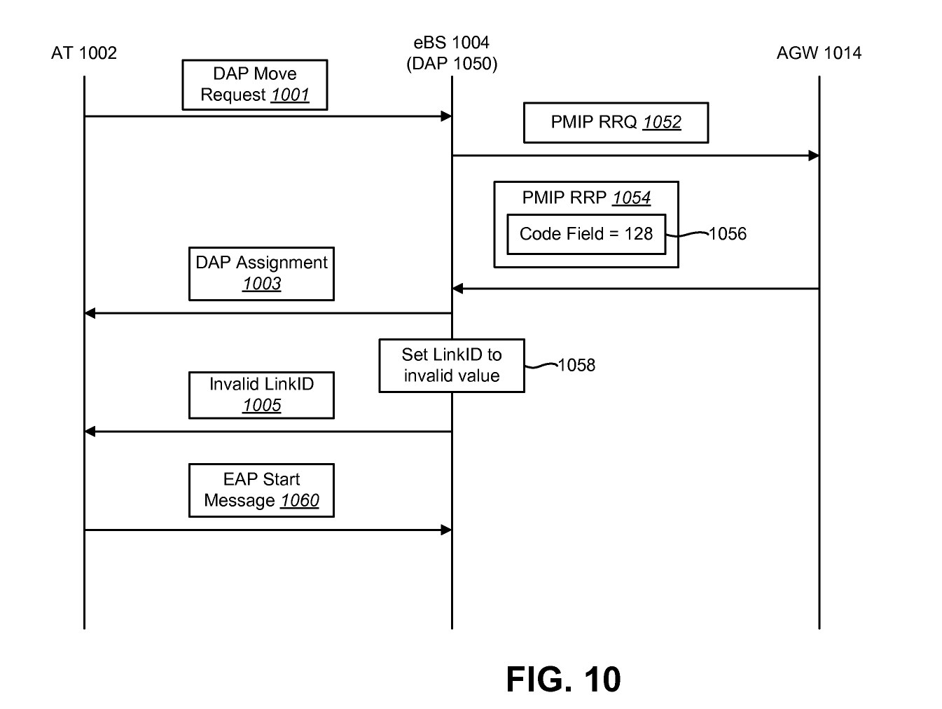

Reference is now made to FIG. 10. FIG. 10 illustrates an example of a possible remedy relating to resource management in the event of PMIP tunnel 116 failure.

An AT 1002 may send a DAP move request 1001 to the DAP 1050, which may be the eBS 1004. The eBS 1004 may send a PMIP Registration Request (RRQ) 1052 to the AGW 1014. However, the AGW 1014 may not have any information for the user of the AT 1002. This scenario can arise, for instance, when the AT 1002 moved away temporarily, and the AGW 1014 thereafter cleans up (e.g., deletes) the resources 118. As a remedy, the AGW 1014 may send a PMIP Registration Response (RRP) 1054 with the Code Field 1056 set to 128 (i.e., reasons unspecified) to the DAP 1050 (eBS 1004).

The DAP 1050 (eBS 1004) may in turn indicate to the AT 1002 to restart the EAP access authentication process. In particular, the DAP 1050 (eBS 1004) may send a DAP assignment message 1003 to the AT 1002. The DAP 1050 may then set 1058 the Link ID to an invalid value. The DAP 1050 (eBS 1004) may thereafter send a message 1005 to the AT 1002 with the invalid Link ID. The AT 1002 may then send an EAP start message 1060 to initiate the EAP authentication process.

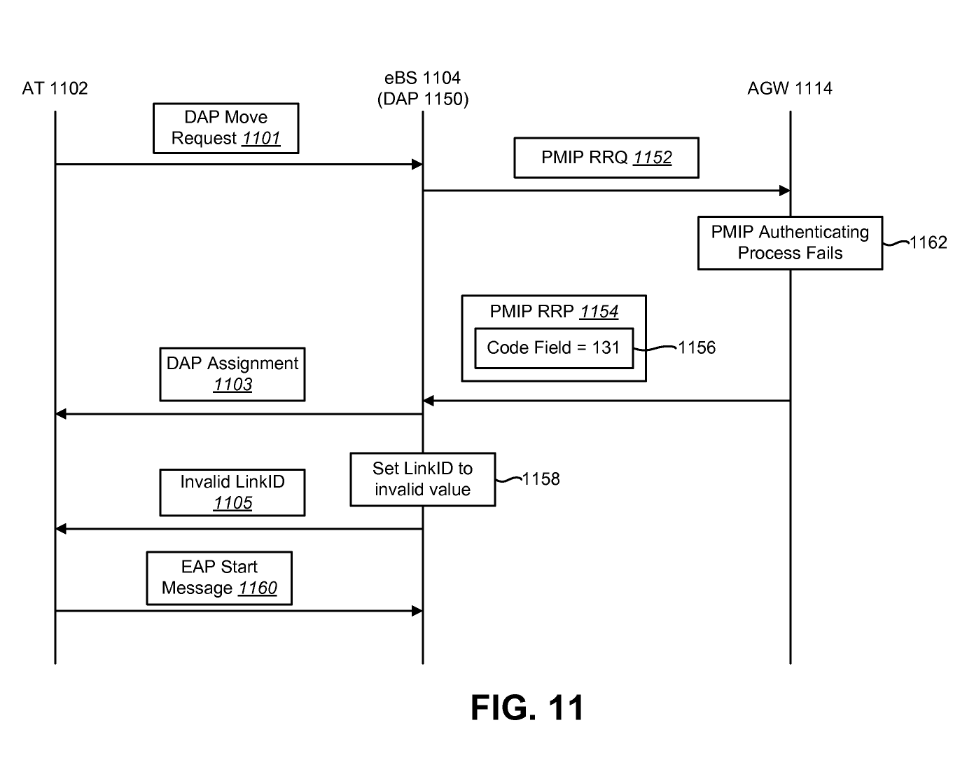

Reference is now made to FIG. 11. FIG. 11 illustrates another example of a possible remedy relating to resource management in the event of PMIP tunnel 116 failure.

An AT 1102 may send a DAP move request 1101 to the DAP 1150, which may be the eBS 1104. The eBS 1104 may send a PMIP Registration Request (RRQ) 1152 to the AGW 1114. Suppose the PMIP authenticating process fails 1162. The AGW 1114 may rectify the situation by sending a PMIP RRP 1154 with the Code Field 1156 set to 131 (i.e., the AT 1102 failed authentication) to the DAP 1150 (eBS 1104). The DAP 1150 (eBS 1104) may then indicate to the AT 1102 to restart the EAP access authentication process. In particular, the DAP 1150 (eBS 1104) may send a DAP assignment message 1103 to the AT 1102. The DAP 1150 may then set 1158 the Link ID to an invalid value. The DAP 1150 (eBS 1104) may thereafter send a message 1105 to the AT 1102 with the invalid Link ID. The AT 1102 may thereafter send the EAP start message 1160 to initiate the EAP authentication process.

In the two scenarios as described above, the AGW 1014, 1114 may be configured so that it does not use the following error codes for PMIP tunnel 116 setup, namely: 129 (administratively prohibited), 132 (FA failed authentication), and 136 (unknown HA address). As for the DAP 1050, 1150, it may be configured to carry out the recovery process when any of the following codes is received, namely: 130 (insufficient resources), 133 (registration ID mismatch), 134 (poorly formed request), and 135 (too many simultaneous mobility bindings).

In some examples as described above, time-sensitive parameters, such as the PMIP lifetime parameter 506, may be used to trigger the resource update. Other parameters can also be used.

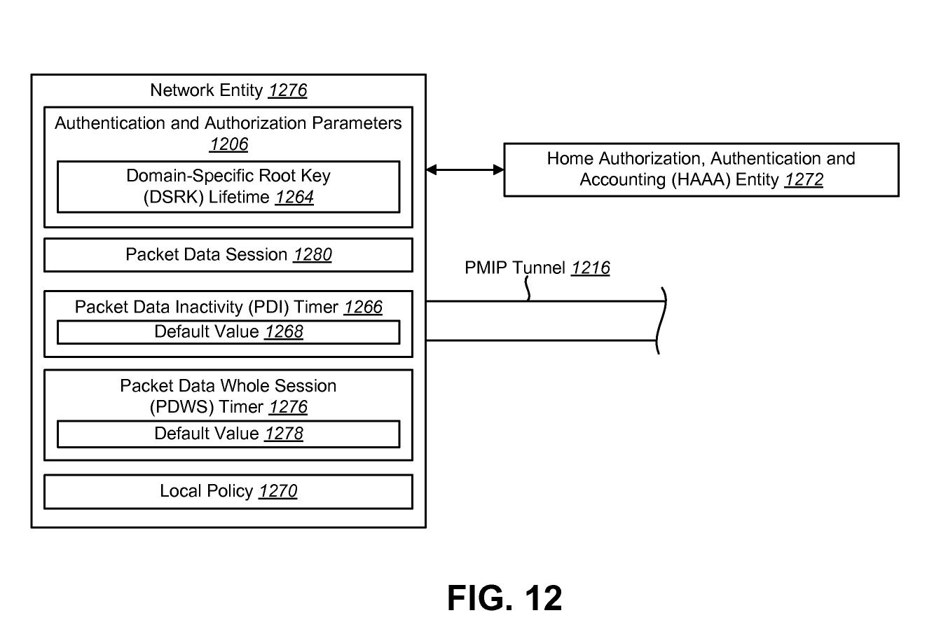

Reference is now made to FIG. 12. FIG. 12 illustrates examples of other ways to trigger the cleaning and/or updating of resources.

In the updating of authentication and authorization parameters 1206, the lifetime 1264 of the Domain-Specific Root Key (DSRK) can be used, if available. As another example, a new timer 1266 can be created for the purpose of updating resources 118, 126, 128, 130. For instance, a Packet Data Inactivity (PDI) timer 1266, which can be similar to the Point-to-Point Inactivity (PPPI) timer, can be created for this specific purpose. The PDI timer 1266 is shown residing on a network entity 1276, which may be an AGW 114, an eBS, 104, etc.

The PDI timer 1266 may be initially set to a default value 1268 based on local policy 1270. The value of the PDI timer 1266 may be overridden by a Home Authorization, Authentication and Accounting (HAAA) entity 1272.

The PDI timer 1266 may be refreshed when any data are received from a PMIP tunnel 1216. However, when the PDI timer 1266 expires after a predetermined period of time, the authentication and authorization parameters 1206 may be updated.

Thus, the PDI timer 1266 is an example of one way to monitor whether the PMIP tunnel 1216 is still needed. Also, expiration of the PDI timer 1266 is an example of an event which indicates that the PMIP tunnel 1216 is no longer needed.

As another example, a Packet Data Whole Session (PDWS) timer 1276, which may be similar to the PPP session timer, may also be created for the purpose of updating resources 118, 126, 128, 130. The PDWS timer 1276 may be initially set to a default value 1278 based on local policy 1270 and can further be overridden by the HAAA entity 1272. However, when the PDWS timer 1276 expires, the packet data session 1280 may be terminated.

Thus, the PDWS timer 1276 is an example of one way to monitor whether the PMIP tunnel 1216 is still needed. Also, expiration of the PDWS timer 1276 is an example of an event which indicates that the PMIP tunnel 1216 is no longer needed.

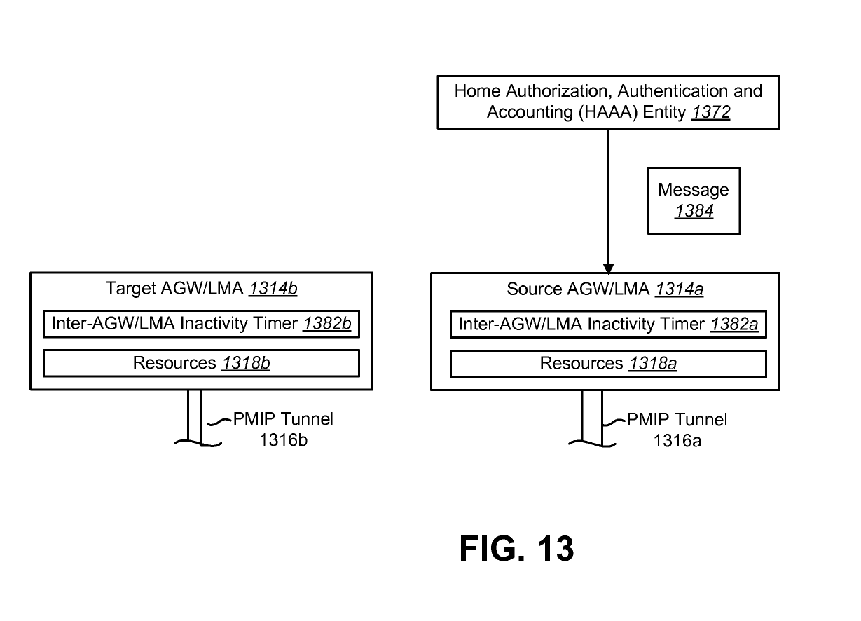

Reference is now made to FIG. 13. FIG. 13 illustrates additional examples of ways to trigger the cleaning and/or updating of resources.

It is also possible that the PMIP tunnels 1316a-b can be simultaneously maintained in both the source AGW/LMA 1314a and the target AGW/LMA 1314b during handoff. In such an arrangement, an inter-AGW/LMA inactivity timer 1382 can be created when any of the AGWs/LMAs 1314 receives a message 1384 from the HAAA 1372. The inter-AGW/LMA inactivity timer 1382 created by the relevant AGW/LMA 1314, be it the source AGW/LMA 1314a or the target AGW/LMA 1314b, may be refreshed when any data is received. When the inter-AGW/LMA inactivity timer 1382 expires after a predetermined period of time, the source AGW/LMA 1314a may clean up (e.g., delete) its resources 1318a.

Thus, the inter-AGW/LMA inactivity timer 1382 is an example of one way to monitor whether the PMIP tunnel 1316a is still needed. Also, expiration of the inter-AGW/LMA inactivity timer 1382 is an example of an event which indicates that the PMIP tunnel 1316a is no longer needed.

Any parameters relied on for initiating the resource update process need not be time-sensitive. A straightforward message requesting resource update can be the starting point for resource update.

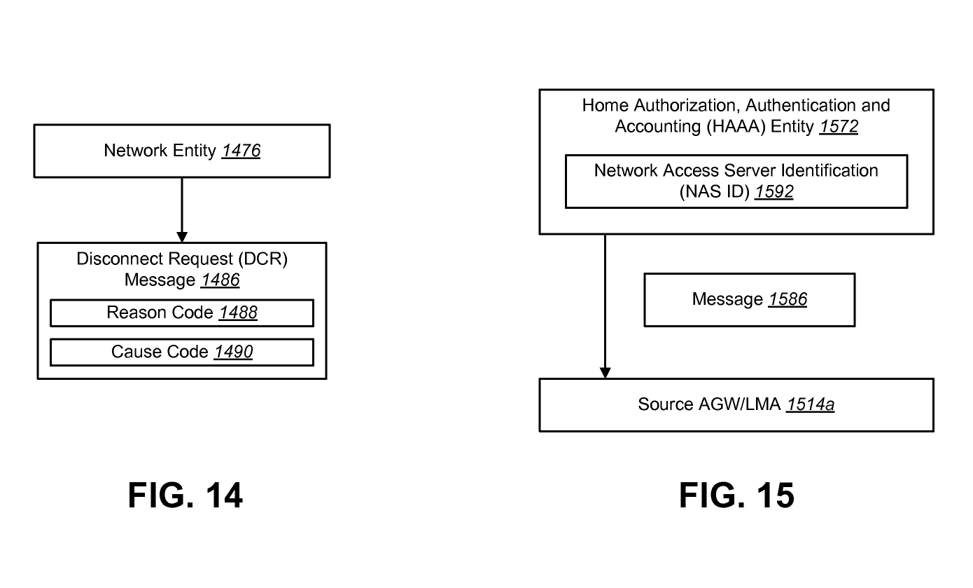

Reference is now made to FIG. 14. FIG. 14 illustrates additional examples of ways to trigger the cleaning and/or updating of resources.

A Disconnect Request (DCR) message 1486 sent by any of the network entities 1476, be it from the AT 102 or other entities 1476 such as the AGW 114, can be used to trigger the resource update process. The message 1486 can be configured in accordance with the Dynamic Authorization Extensions to RADIUS format as set forth in RFC 3576, or the Use Disconnect Peer-Request/Answer in Diameter format as set forth in RFC 3588. For the former, it may be desirable for the message to be coupled with a reason code 1488. Likewise, for the latter, it may be desirable for the message 1486 to be accompanied with a cause code 1490.

Reference is now made to FIG. 15. FIG. 15 illustrates additional examples of ways to trigger the cleaning and/or updating of resources.

Another example of using messages to initiate the resource update process is by having an HAAA entity 1572 send a message 1586 to the prior (i.e., source) AGW/LMA 1514a when the HAAA entity 1572 detects an inter-AGW/LMA 1514 handoff. The detection can be made possible by having the HAAA entity 1572 monitoring the Network Access Server Identification (NAS ID) 1592 which is available to the HAAA 1572 during the EAP registration process as described above.

In addition to the aforementioned entities, such as the HA server 1 12, the AGW 114, the eBS 104, or the AT 102, that may update resources 118, 126, 128, 130 as described above, other entities may also update resources in a similar manner. An example is an AAA server be it a HAAA (Home-AAA) server or a VAAA (Visitor-AAA) server. The AAA entity can be connected to or part of the AGW 114. For example, during an inter-AGW 114 handoff, all the resource information in the AAA may be updated.

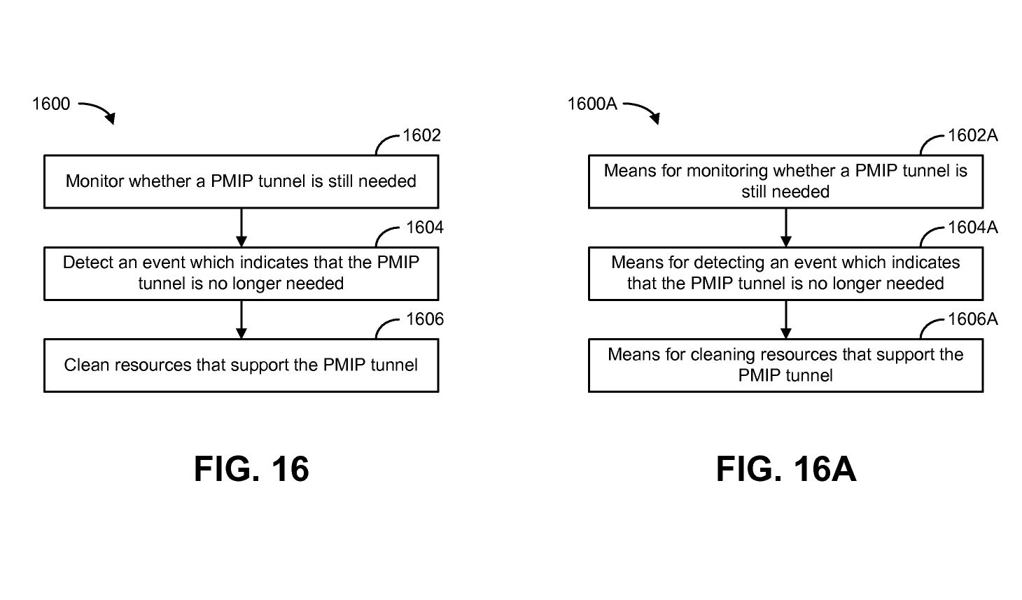

FIG. 16 illustrates a method 1600 for management of resources 118, 126, 128, 130 in a communication network 100. The method 1600 may be implemented by a network entity (e.g., an AGW 114, an eBS 104, an HMA/LMA 112, etc.). The method 1600 may be performed at some point after a Proxy Mobile Internet Protocol (PMIP) tunnel 116 has been established between the network entity and another network entity.

The method 1600 may include monitoring 1602 whether the PMIP tunnel 116 between the network entity and another network entity is still needed. For example, a PMIP lifetime parameter 506 may be monitored. As another example, a Packet Data Inactivity (PDI) timer 1266 may be monitored. As another example, a Packet Data Whole Session (PDWS) timer 1276 may be monitored. As another example, an inter-gateway inactivity timer 1382 may be monitored.

The method 1600 may also include detecting 1604 an event which indicates that the PMIP tunnel 116 is no longer needed. For example, the expiration of the PMIP lifetime parameter 506 may be detected. As another example, the expiration of the PDI timer 1266 may be detected. As another example, the expiration of the PDWS timer 1276 may be detected. As another example, the expiration of the inter-gateway inactivity timer 1382 may be detected.

The method 1600 may also include cleaning resources 118 of the network entity that support the PMIP tunnel 116. For example, IP addresses 210 corresponding to the PMIP tunnel 116 may be released. As another example, authentication and authorization parameters 306 may be updated.

The method 1600 of FIG. 16 described above may be performed by various hardware and/or software component(s) and/or module(s) corresponding to the means-plus-function blocks 1600A illustrated in FIG. 16A. In other words, blocks 1602 through 1606 illustrated in FIG. 16 correspond to means-plus-function blocks 1602A through 1606A illustrated in FIG. 16A.

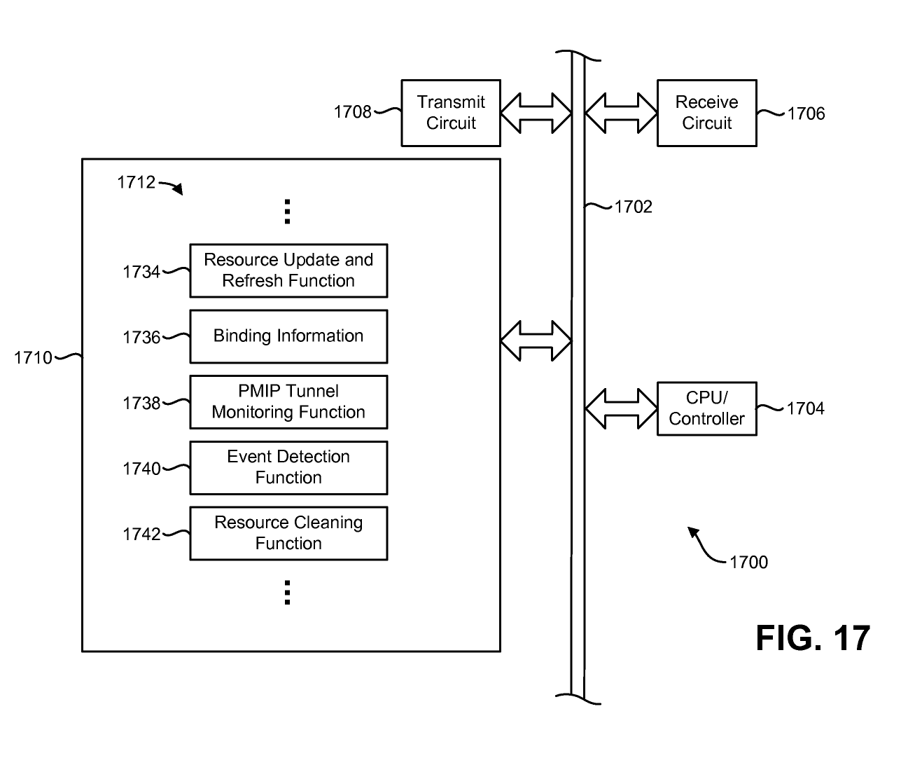

FIG. 17 shows part of a hardware implementation of an apparatus 1700 for resource management in a communication network 100, as described above. The circuit apparatus is signified by the reference numeral 1700 and may be implemented in a network entity (e.g., an AGW 114, eBS 104, HA/LMA 112, etc.). Alternatively, the apparatus 1700 can be built into an AT 102. For example, in an AT-assisted mode as mentioned above, information concerning the bindings 120, 123 may be directed to the AT 102. The AT 102 may then either initiate, cause to initiate, or inform the relevant entities within the communication network 100 (such as the AGW 114, the eBS 104, etc.) regarding the resource update or refresh process.

The apparatus 1700 comprises a central data bus 1702 linking several circuits together. The circuits include a CPU (Central Processing Unit) or a controller 1704, a receive circuit 1706, a transmit circuit 1708, and a memory unit 1710.

If the apparatus 1700 is part of a wireless device, the receive and transmit circuits 1706 and 1708 can be connected to an RF (Radio Frequency) circuit, but that is not shown in the drawing. The receive circuit 1706 may process and buffer received signals before sending the signals out to the data bus 1702. On the other hand, the transmit circuit 1708 may process and buffer the data from the data bus 1702 before sending the data out of the device 1700. The CPU/controller 1704 may perform the function of data management of the data bus 1702 and further the function of general data processing, including executing the instructional contents of the memory unit 1710.

Instead of separately disposed as shown in FIG. 17, as an alternative, the transmit circuit 1708 and the receive circuit 1706 may be parts of the CPU/controller 1704.

The memory unit 1710 includes a set of modules and/or instructions generally signified by the reference numeral 1712. The modules/instructions 1712 may include, among other things, a resource update and refresh function 1734, and binding information 1736. The resource update and refresh function 1734 may incorporate the processes as previously described. The binding information 1736 may comprise parameters for the relevant bindings 120, 124 (e.g., user profiles 310, IP addresses 210, etc.), also explained above.

The modules/instructions 1712 may also include a function 1738 for monitoring whether a PMIP tunnel 716 between an AGW 114 and an access network 106 is still needed. For example, this function 1738 may implement monitoring of a PMIP lifetime parameter 506. As another example, this function 1738 may implement monitoring of a Packet Data Inactivity (PDI) timer 1266. As another example, this function 1738 may implement monitoring of a Packet Data Whole Session (PDWS) timer 1276. As another example, this function 1738 may implement monitoring of an inter-gateway inactivity timer 1382.

The modules/instructions 1712 may also include a function 1740 for detecting an event which indicates that the PMIP tunnel 116 is no longer needed. For example, this function 1740 may implement detection of the expiration of the PMIP lifetime parameter 506. As another example, this function 1740 may implement detection of the expiration of the PDI timer 1266. As another example, this function 1740 may implement detection of the expiration of the PDWS timer 1276. As another example, this function 1740 may implement detection of the expiration of the inter-gateway inactivity timer 1382.

The modules/instructions 1712 may also include a function 1742 for cleaning resources 118 of an AGW 114 that support the PMIP tunnel 1 16. For example, this function 1742 may implement the releasing of IP addresses 210 corresponding to the PMIP tunnel 116. As another example, this function 1742 may implement the updating of authentication and authorization parameters 306.

The memory unit 1710 may be a RAM (Random Access Memory) circuit. The resource update and refresh function 1734, binding information 1736, PMIP tunnel monitoring function 1738, event detection function 1740, and resource cleaning function 1742 shown in the memory unit 1710 may be software routines, modules and/or data sets. The memory unit 1710 can be tied to another memory circuit (not shown) which can either be of the volatile or nonvolatile type. As an alternative, the memory unit 1710 can be made of other circuit types, such as an EEPROM (Electrically Erasable Programmable Read Only Memory), an EPROM (Electrical Programmable Read Only Memory), a ROM (Read Only Memory), an ASIC (Application Specific Integrated Circuit), a magnetic disk, an optical disk, and others well known in the art.

It should be further be noted that the inventive processes as described can also be coded as computer-readable instructions carried on any computer-readable medium known in the art. In this specification and the appended claims, the term “computer-readable medium” refers to any medium that participates in providing instructions to any processor, such as the CPU/controller 1704 shown and described in the drawing figure of FIG. 17, for execution. Such a medium can be of the storage type and may take the form of a volatile or non-volatile storage medium as also described previously, for example, in the description of the memory unit 1710 in FIG. 17.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the terms “code” and “instructions” should be interpreted broadly to include any type of computer-readable statement(s). For example, the terms “code” and “instructions” may refer to one or more programs, routines, sub-routines, functions, procedures, etc.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated by FIG. 16, can be downloaded and/or otherwise obtained by a subscriber station and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a subscriber station and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A network entity that is configured for resource management in a communication network, comprising:
a processor; and
circuitry coupled to the processor configured to monitor a Proxy Mobile Internet Protocol (PMIP) tunnel between the network entity and another network entity, detect an event which indicates that the PMIP tunnel is no longer needed, and clean resources of the network entity that support the PMIP tunnel.

2. The network entity of claim 1, wherein the circuitry coupled to the processor is further configured to detect expiration of a PMIP lifetime parameter.

3. The network entity of claim 1, wherein the circuitry coupled to the processor is further configured to detect expiration of a Packet Data Inactivity (PDI) timer.

4. The network entity of claim 1, wherein the circuitry coupled to the processor is further configured to detect expiration of a Packet Data Whole Session (PDWS) timer.

5. The network entity of claim 1, wherein the circuitry coupled to the processor is further configured to detect expiration of an inter-gateway inactivity timer.

6. The network entity of claim 1, wherein the circuitry coupled to the processor is further configured to detect releasing Internet Protocol (IP) addresses.

7. The network entity of claim 1, wherein the circuitry coupled to the processor is further configured to detect updating authentication and authorization parameters.

8. The network entity of claim 1, wherein the PMIP tunnel corresponds to an access terminal, and wherein the circuitry is further configured to:
receive a PMIP registration request from the access network after the resources have been cleaned; and
indicate to the access terminal to restart access authentication.

9. A network entity that is configured for resource management in a communication network, comprising:
means for monitoring whether a Proxy Mobile Internet Protocol (PMIP) tunnel between the network entity and another network entity is still needed;
means for detecting an event which indicates that the PMIP tunnel is no longer needed; and
means for cleaning resources of the network entity that support the PMIP tunnel.

10. The network entity of claim 9, wherein the means for detecting the event comprises means for detecting expiration of a PMIP lifetime parameter.

11. The network entity of claim 9, wherein the means for detecting the event comprises means for detecting expiration of a Packet Data Inactivity (PDI) timer.

12. The network entity of claim 9, wherein the means for detecting the event comprises means for detecting expiration of a Packet Data Whole Session (PDWS) timer.

13. The network entity of claim 9, wherein the means for detecting the event comprises means for detecting expiration of an inter-gateway inactivity timer.

14. The network entity of claim 9, wherein the means for cleaning the resources comprises means for releasing Internet Protocol (IP) addresses.

15. The network entity of claim 9, wherein the means for cleaning the resources comprises means for updating authentication and authorization parameters.

16. The network entity of claim 9, wherein the PMIP tunnel corresponds to an access terminal, and further comprising:
means for receiving a PMIP registration request from the access network after the resources have been cleaned; and
means for indicating to the access terminal to restart access authentication.

17. A computer product for resource management in a communication network, the computer product including a computer-readable medium comprising physically embodied computer-readable code for:
monitoring whether a Proxy Mobile Internet Protocol (PMIP) tunnel between a network entity and another network entity is still needed;
detecting an event which indicates that the PMIP tunnel is no longer needed; and
cleaning resources of the network entity that support the PMIP tunnel.

18. The computer product of claim 17, wherein detecting the event comprises detecting expiration of a PMIP lifetime parameter.

19. The computer product of claim 17, wherein detecting the event comprises detecting expiration of a Packet Data Inactivity (PDI) timer.

20. The computer product of claim 17, wherein detecting the event comprises detecting expiration of a Packet Data Whole Session (PDWS) timer.

21. The computer product of claim 17, wherein detecting the event comprises detecting expiration of an inter-gateway inactivity timer.

22. The computer product of claim 17, wherein cleaning the resources comprises releasing Internet Protocol (IP) addresses.

23. The computer product of claim 17, wherein cleaning the resources comprises updating authentication and authorization parameters.

24. The computer product of claim 17, wherein the PMIP tunnel corresponds to an access terminal, and wherein the computer-readable medium further comprises computer-readable code for:
receiving a PMIP registration request from the access network after the resources have been cleaned; and
indicating to the access terminal to restart access authentication.

25. A method for resource management in a communication network, the method being implemented by a network entity, the method comprising:
monitoring whether a Proxy Mobile Internet Protocol (PMIP) tunnel between the network entity and another network entity is still needed;
detecting an event which indicates that the PMIP tunnel is no longer needed; and
cleaning resources of the network entity that support the PMIP tunnel.

26. The method of claim 25, wherein detecting the event comprises detecting expiration of a PMIP lifetime parameter.

27. The method of claim 25, wherein detecting the event comprises detecting expiration of a Packet Data Inactivity (PDI) timer.

28. The method of claim 25, wherein detecting the event comprises detecting expiration of a Packet Data Whole Session (PDWS) timer.

29. The method of claim 25, wherein detecting the event comprises detecting expiration of an inter-gateway inactivity timer.

30. The method of claim 25, wherein cleaning the resources comprises releasing Internet Protocol (IP) addresses.

31. The method of claim 25, wherein cleaning the resources comprises updating authentication and authorization parameters.

32. The method of claim 25, wherein the PMIP tunnel corresponds to an access terminal, and further comprising:
receiving a PMIP registration request from the access network after the resources have been cleaned; and
indicating to the access terminal to restart access authentication.
